(19) United States
(12) Patent Application Publication
(10) Pub. No.: US 2016/0050599 A1
(43) Pub. Date: Feb. 18, 2016

(54) POWER SCAN FOR ESTABLISHING CIRCUIT SWITCHED FALLBACK (CSFB) CALL

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/457,597

(22) Filed: Aug. 12, 2014

(51) Int. Cl. H04W 36/14; H04W 36/30; H04W 36/00; H04B 1/3816

(52) U.S. Cl. CPC H04W 36/14; H04B 1/3816; H04W 36/30; H04W 36/0005

(57) ABSTRACT

In a method of wireless communication, a UE receives a redirection message from a first radio access technology (RAT) to move to a second RAT. The UE scans frequencies of the second RAT indicated in the received redirection message from the first RAT and does not detect a cell. The UE scans a third RAT and collects system information from a detected cell in the third RAT but does not camp on the detected cell in the third RAT. The UE scans frequencies of the second RAT indicated in the collected system information and detects a cell. The UE then performs a call setup with the detected cell of the second RAT.

### BACKGROUND

1. Field

Aspects of the present disclosure relate generally to wireless communication systems, and more particularly, to circuit-switched fallback from LTE to 3G/2G networks.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes receiving a redirection message from a first radio access technology (RAT) to move to a second RAT. The method also includes scanning frequencies of the second RAT indicated in the received redirection message from the first RAT and not detecting a cell. A third RAT is scanned and system information is collected from a detected cell in the third RAT but the UE does not camp on the detected cell in the third RAT. Frequencies of the second RAT indicated in the collected system information are scanned. A cell is detected when scanning frequencies of the second RAT indicated in the collected system information and a call setup is performed with the detected cell of the second RAT.

Another aspect discloses an apparatus including means for receiving a redirection message from a first radio access technology (RAT) to move to a second RAT. The apparatus also includes a means for scanning frequencies of the second RAT indicated in the received redirection message from the first RAT while not detecting a cell and a means for scanning a third RAT. The apparatus also includes means for collecting system information from a detected cell in the third RAT but not camping on the detected cell in the third RAT. The apparatus also includes means for scanning frequencies of the second RAT indicated in the collected system information. The apparatus also includes means for detecting a cell when scanning frequencies of the second RAT indicated in the collected system information and means for performing a call setup with the detected cell of the second RAT.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of receiving a redirection message from a first radio access technology (RAT) to move to a second RAT. The program code also causes the processor(s) to scan frequencies of the second RAT indicated in the received redirection message from the first RAT and not detecting a cell, and to scan a third RAT. The program code also causes the processor(s) to collect system information from a detected cell in the third RAT and to not camp on the detected cell in the third RAT and to scan frequencies of the second RAT indicated in the collected system information. The program code also causes the processor(s) to detect a cell when scanning frequencies of the second RAT indicated in the collected system information and to perform a call setup with the detected cell of the second RAT.

Another aspect discloses wireless communication having a memory and at least one processor coupled to the memory. The processor(s) is configured to receive a redirection message from a first radio access technology (RAT) to move to a second RAT. The processor(s) is also configured to scan frequencies of the second RAT indicated in the received redirection message from the first RAT when a cell is not detected to scan a third RAT. The processor(s) is further configured to collect system information from a detected cell in the third RAT but to not camp on the detected cell in the third RAT. The processor(s) is also configured to scan frequencies of the second RAT indicated in the collected system information. The processor(s) is also configured to detect a cell when scanning frequencies of the second RAT indicated in the collected system information and to perform a call setup with the detected cell of the second RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIGS. 5A-B are call flow diagrams illustrating method for call setup according to one aspect of the present disclosure.

FIG. 6 is a block diagram illustrating a method for call setup according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

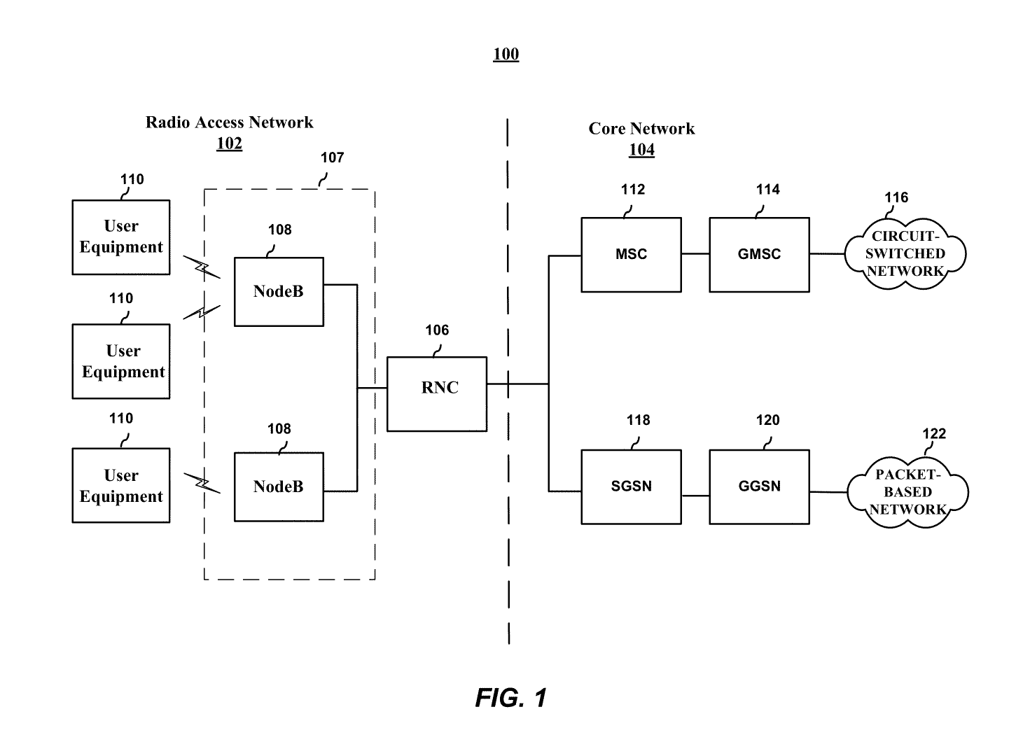

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

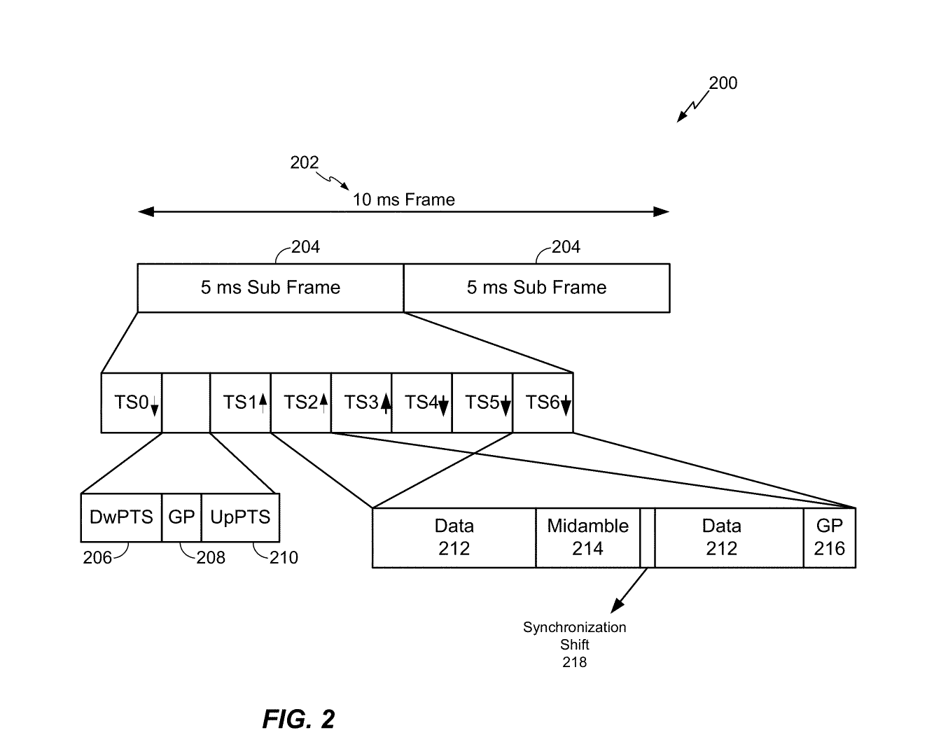

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

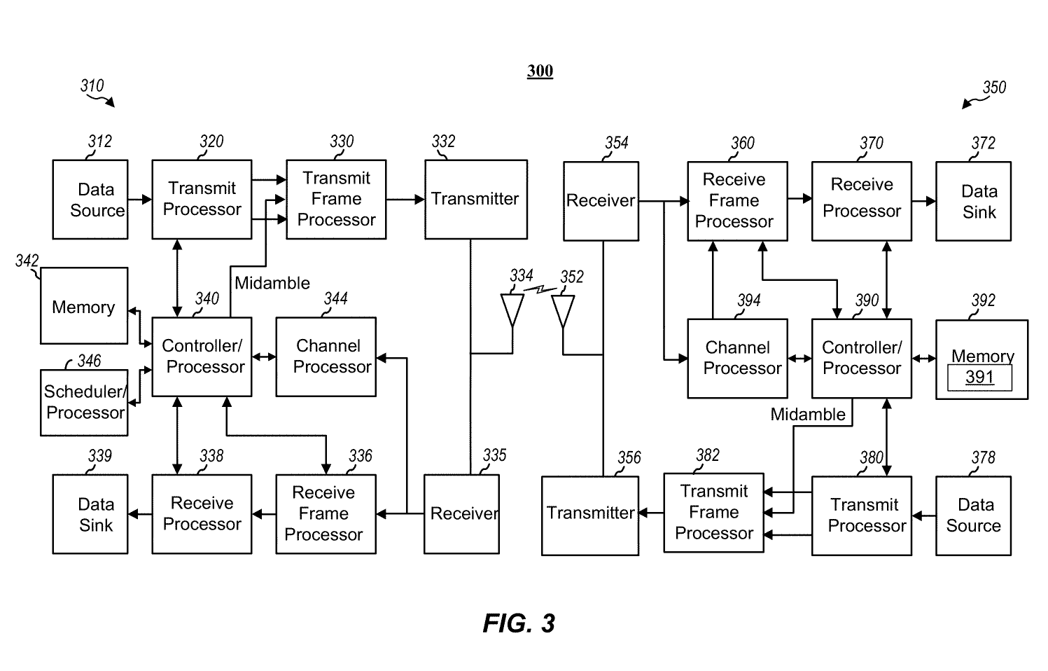

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a call setup module 391 which, when executed by the controller/processor 390, configures the UE 350 for performing scans on various frequencies. A scheduler/processor 346 at the node B 310 may be used to allocate resources to the UEs and schedule downlink and/or uplink transmissions for the UEs.

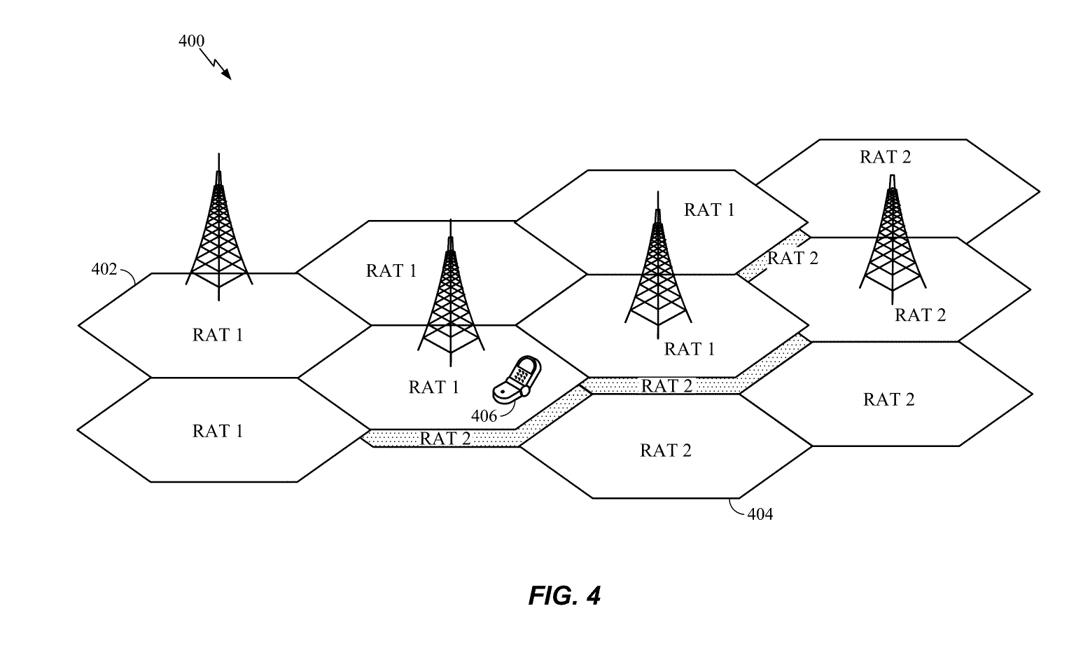

Some networks, such as a newly deployed network, may cover only a portion of a geographical area. Another network, such as an older more established network, may better cover the area, including remaining portions of the geographical area. FIG. 4 illustrates coverage of an established network utilizing multiple types of radio access technology (RAT) network, such as, for example, GSM (2G), TD-SCDMA (3G) and/or LTE (4G). The geographical area 400 may include RAT-1 cells 402 and RAT-2 cells 404. In one example, the RAT-1 cells are 2G or 3G cells and the RAT-2 cells are LTE -SCDMA cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., 2G and/or 3G) a UE may be specified to perform a measurement of a neighboring cell (such as a LTE cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Circuit-switched fallback (CSFB) is a feature that enables multimode UEs that are capable of 3G/2G in addition to LTE, to utilize circuit switched (CS) voice services while being camped on LTE. A CSFB capable UE may initiate a mobile-originated (MO) CS voice call while camping on LTE, resulting in the UE being redirected to a circuit switched RAT, such as 3G or 2G for circuit switched voice call setup. A CSFB capable UE may be paged for a mobile-terminated (MT) voice call while on LTE, resulting in the UE being redirected to 3G or 2G for a circuit switched voice call.

Call establishment latency is a factor used to evaluate CSFB performance. The UE cannot perform power scans on all of the frequencies deployed for operators because a full power scan may takes 20 or more seconds, which is not accepted under CSFB call latency performance specifications.

A redirection command can include a list of 2G absolute radio frequency channel numbers (ARFCN). The UE performs a power scan for all ARFCNs in the list, and then performs acquisition based on a power scan received signal strength indication (RSSI) level (e.g., FCCH tone detection, SCH BSIC detection, etc.). After successful acquisition, the UE obtains system information carried in a system information broadcast (SIB) collection on the detected best cell. The UE then attempts to establish a circuit switched call.

When the UE performs the first power scan for all ARFCNs received in the redirection command list, not all the ARFCNs may be viable for all possible locations in the LTE coverage area due to load and radio frequency (RF) variation. According to an aspect of the present disclosure, the UE attempts to collect SIBs from the broadcast control channel (BCCH) for the best cell detected during the first power scan. If the UE fails (e.g., RACH failure, RRC establishment failure), the UE performs a second power scan in the neighbors indicated in the BCCH of the best cell detected during the first power scan. Additionally, if the UE fails to decode the BCCH of the best cells during the first power scan, the UE does not know the neighbor cells of the best cells during the first power scan. In this case, the UE may only perform one power scan in the ARFCNs received in the redirection command.

The best cells detected during the first and second power scans may not be viable for all possible locations in the LTE (4G) network. When the best cell obtained during these power scans is weak and not viable for call establishment, CSFB failure may result, even though viable, undetected cells were located in the failed locations.

In one aspect of the present disclosure, the UE receives a redirection command from a first RAT to move from the first RAT (e.g. LTE) to a second RAT (GSM or 2G). The redirection command includes a listing of frequencies in the second RAT (e.g., listing of frequencies in 2G). The UE performs a scan of all 2G frequencies indicated in the redirection command. When the UE does not detect any cells, the UE performs a scan of a third RAT (e.g., 3G). The third RAT provides additional frequencies of second RAT neighbors (e.g., 2G neighbors), thereby providing the UE a listing of additional options for call setup in the second RAT.

The UE does not camp on the detected cell in the third RAT, but does collect system information. The UE then performs a scan of the 2G frequencies indicated in the collected system information. In one aspect, the UE scans all of the 2G frequencies indicated in the system information. Alternately, the UE may scan only the frequencies of the second RAT that are different from the ones indicated in the redirection command. After the UE detects a viable cell of the second RAT (e.g., 2G) from the scan, the UE then performs a call setup with the detected 2G cell.

In another aspect, after UE performs a scan of the frequencies listed in the redirection command, the UE finds a 2G cell that is not viable for call setup. The UE may collect system information (e.g., system information broadcasts (SIBs)) from the detected cell. The collected system information may indicate other viable neighbor GSM cells. Optionally, in another aspect, when the UE is on the first RAT, such as LTE, the LTE network may indicate a listing of 3G neighbor cells not included in the redirection command. The UE can scan these frequencies indicated by the LTE network and/or the frequencies indicated by the 2G network. In one aspect, only the differing frequencies are scanned.

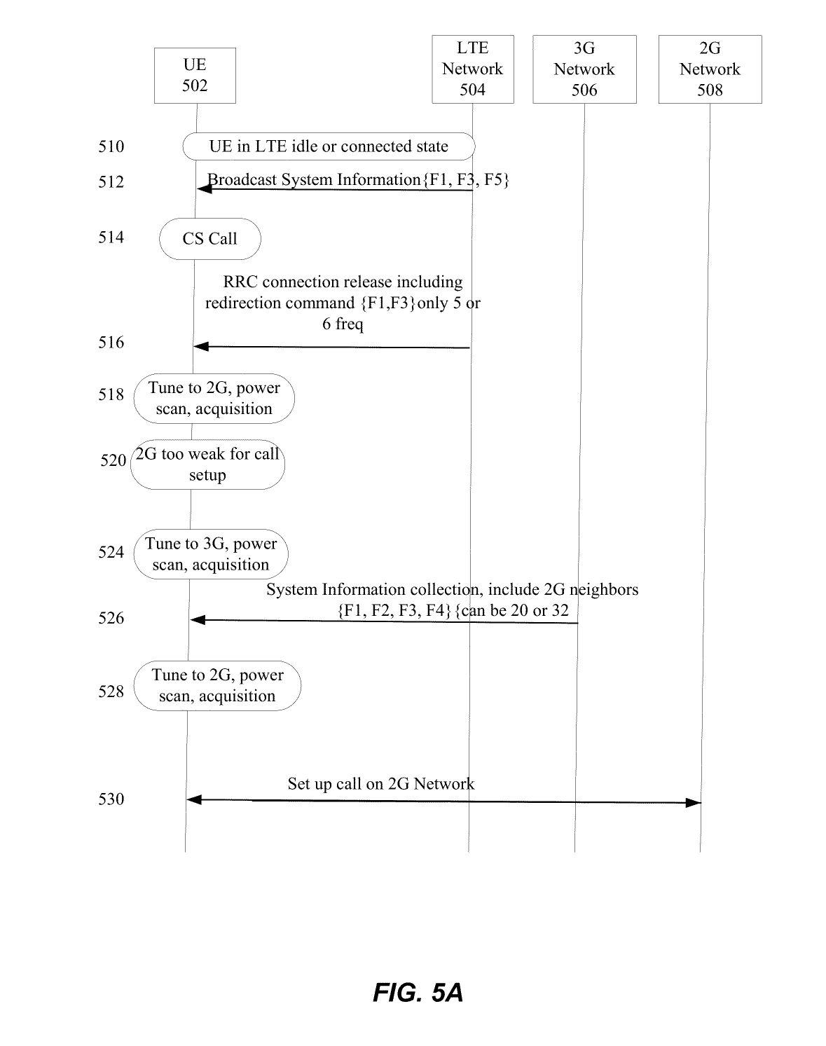

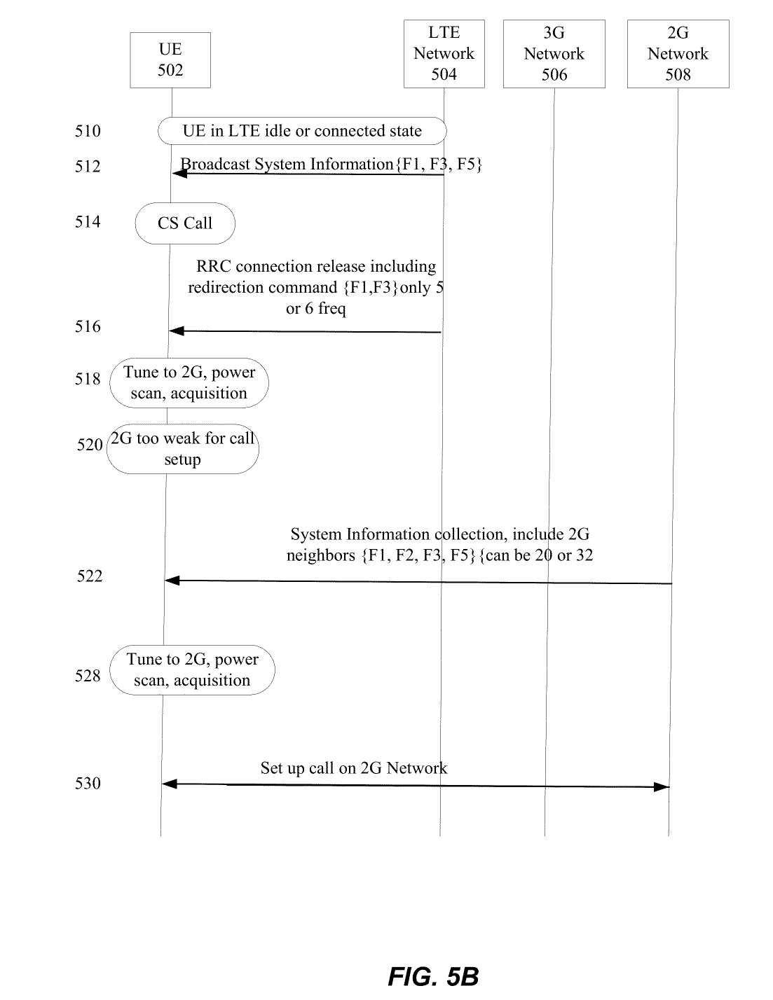

Referring to FIG. 5A, a call setup procedure in accordance with aspects of the present disclosure will be explained. At time 510, a UE 502 is in idle mode or connected mode with a first RAT 504, such as LTE. At time 512, the UE 502 receives system information by the first RAT 504. The system information can be received from a broadcast system information block (SIB) when in idle mode or a dedicated neighbor information message when in connected mode. The system information includes frequencies for neighbor cells. In this example, the system information includes frequencies F1, F3, and F5 for a second RAT 508, such as a 2G network. Frequencies for a third RAT 506 may also be provided, but are not shown in FIG. 5A. This information may be stored in a buffer at the UE 502.

At time 514, a circuit switched call occurs. The voice call can be either mobile initiated or mobile terminated. In response to the circuit switched call, a circuit switched fall back procedure begins to transition the UE 502 from the LTE network 504 to a circuit switched RAT that can support the voice call. In this case the call will be set up on a 2G network 508. As part of the circuit switched fall back procedure, at time 516, the LTE network sends a radio resource control (RRC) connection release message to the UE 502. The connection release message includes redirection information, such as frequencies F1 and F3 for 2G neighbor cells.

At time 518, the UE 502 tunes frequencies F1 and F3 of the 2G RAT 508 to attempt to set up the voice call. Thus, the UE performs a power scan, and attempts to acquire the frequencies indicated in the redirection command (i.e., frequencies F1 and F3.) In this example, the frequencies F1 and F3 are too weak for call setup (520). Thus, at time 524, the UE 502 tunes to a third network 506, such as a 3G network. The frequencies of the third network 506 can be indicated in the broadcast system information, at time 512.

At time 524, the UE 502 performs a power scan and attempts acquisition on the 3G network 506. At time 526, the UE 502 collects system information from the 3G network. The system information includes a list of 2G neighbor frequencies. In this example, the list includes frequencies F1, F2, F3, and F4. The list of neighbor frequencies can be larger than the list of frequencies indicated in the redirection command at time 516. It is not desirable for the UE 502 to set up the call on the 3G network, in this example, because the 4G network 504 and the 2G network 508 have previously communicated with respect to the circuit switched call. The 3G network 506 is unaware of the call.

Based on the list of frequencies received at time 526, the UE 502 tunes to the 2G network 508 at time 528. The UE 502 then performs a power scan and system acquisition for the 2G network 508. In one configuration, only the new frequencies, i.e., F2 and F4, are searched. Due to the fact that more frequencies have been searched, it is more likely that a viable 2G cell is located. Thus, at time 530, the UE 502 connects to the 2G network 508 to set up the voice call.

In some aspects, the UE 502 also searches the frequencies received at time 512. These frequencies can be searched at time 518 or time 528. However, it is possible that the list of frequencies received at time 512 is the same as the list received in the redirection command at time 516.

Referring to FIG. 5B, a call setup procedure in accordance with another aspect of the present disclosure will be explained. At time 510, a UE 502 is in idle mode or connected mode with a first RAT 504, such as LTE. At time 512, the UE 502 receives system information broadcast by the first RAT 504. The system information includes frequencies for neighbor cells. In this example, the system information includes frequencies F1, F3, and F5 for a second RAT 508, such as a 2G network. This information may be stored in a buffer at the UE 502.

At time 514, a circuit switched call occurs. The call can be either mobile initiated or mobile terminated. In response to the circuit switched call, a circuit switched fall back procedure occurs to transition the UE 502 from LTE 504 to a circuit switched RAT that can support the voice call. In this case, the call will be set up on a 2G network 508. As part of the circuit switched fall back procedure, at time 516, the LTE network sends a radio resource control (RRC) connection release message to the UE 502. The connection release message includes redirection information, such as frequencies F1 and F3 for 2G neighbor cells.

At time 518, the UE 502 tunes to the 2G RAT 508 to attempt to set up the voice call. Thus, the UE performs a power scan, and attempts to acquire the frequencies indicated in the redirection command (i.e., frequencies F1 and F3.) In this example, the frequencies F1 and F3 are too weak for call setup (520). However, the signaling on those frequencies is strong enough for the UE 502 to be able to collect system information from the corresponding cells at time 522. The system information includes frequencies of 2G neighbors. In this example, the frequencies are F1, F2, F3, and F5. Generally, the number of neighbor frequencies indicated in system information of the 2G network 508 exceeds the number of frequencies indicated in a redirection command.

Based on the list of frequencies received at time 522, the UE 502 tunes to the 2G network 508 at time 528. The UE 502 then performs a power scan and system acquisition. Due to the fact that more frequencies have been searched, it is more likely that a viable 2G cell is located. Thus, at time 530, the UE 502 connects to the 2G network 508 to set up the voice call.

In some aspects, a user equipment (UE) may have more than one subscriber identity module (SIM) or universal subscriber identity module (USIM). A UE with more than one SIM may be referred to as a multi-SIM device. In the present disclosure, a SIM may refer to a SIM or a USIM. Each SIM may also include a unique International Mobile Subscriber Identity (IMSI) and service subscription information. Each SIM may be configured to operate in a particular radio access technology. Moreover, each SIM may have full phone features and be associated with a unique phone number. Therefore, the UE may use each SIM to send and receive phone calls.

When the UE supports multiple receivers with multiple SIMs, the UE may use circuit switched (CS) RAT measurement results to select the target cell for CSFB call establishment. That is, the UE can perform a scan of frequencies in the redirection command/message for the first SIM. The UE can then compare those results with the measurement results derived from the second SIM. The UE then selects the best cell for the first SIM CSFB procedure based on the comparison.

Alternately, the UE may directly select the serving cell of other SIMs in a circuit switched RAT for CSFB call establishment. That is, the UE skips performing the scan of the frequencies listed in the redirection command, thereby going directly to a serving cell of a second SIM for the CSFB call of the first SIM. Thus, call setup latency is reduced.

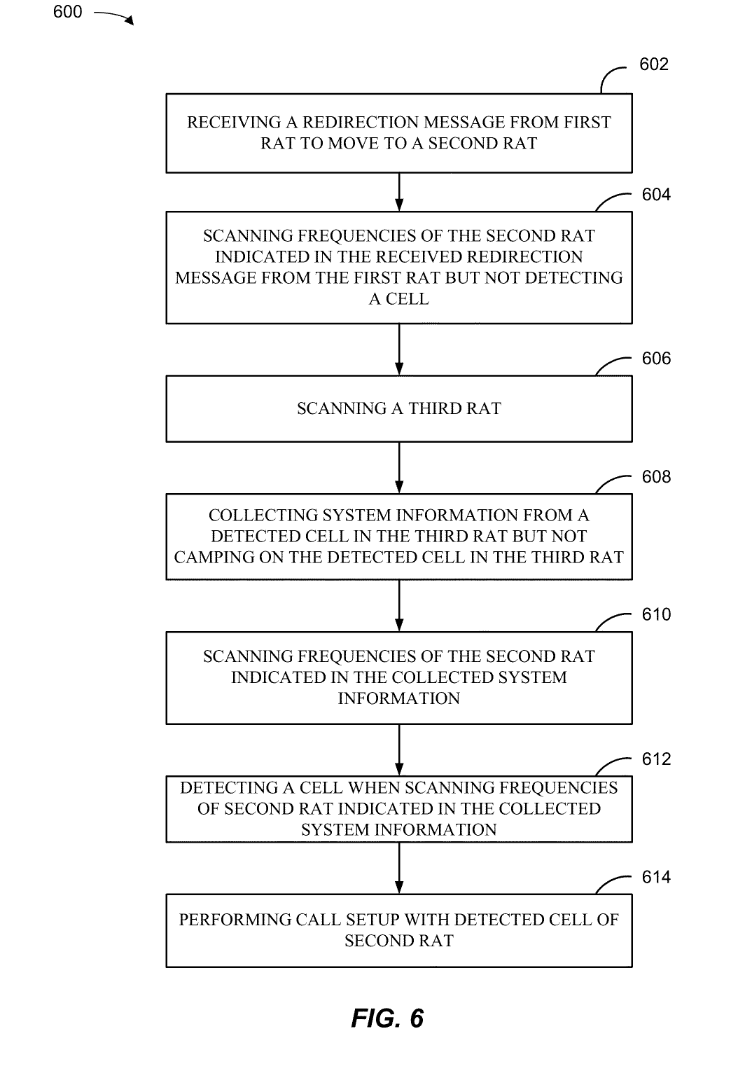

FIG. 6 shows a wireless communication method 600 according to one aspect of the disclosure. A UE receives a redirection message from first RAT to move to a second RAT, as shown in block 602. In one example, the first RAT is LTE and the second RAT is a 2G network, such as GSM. Next, in block 604, the UE scans frequencies of the second RAT indicated in the received redirection message from the first RAT but the UE does not detect a viable 2G cell. In block 606, the UE scans a third RAT. In one example, the third RAT is a 3G network. In block 608, the UE collects system information from a detected cell in the third RAT but does not camp on the detected cell in the third RAT. The UE scan frequencies of the second RAT indicated in the collected system information, at block 610. Next, in block 612, the UE detect a cell when scanning frequencies of the second RAT indicated in the collected system information. The UE performs a call setup with the detected cell of the second RAT in block 614.

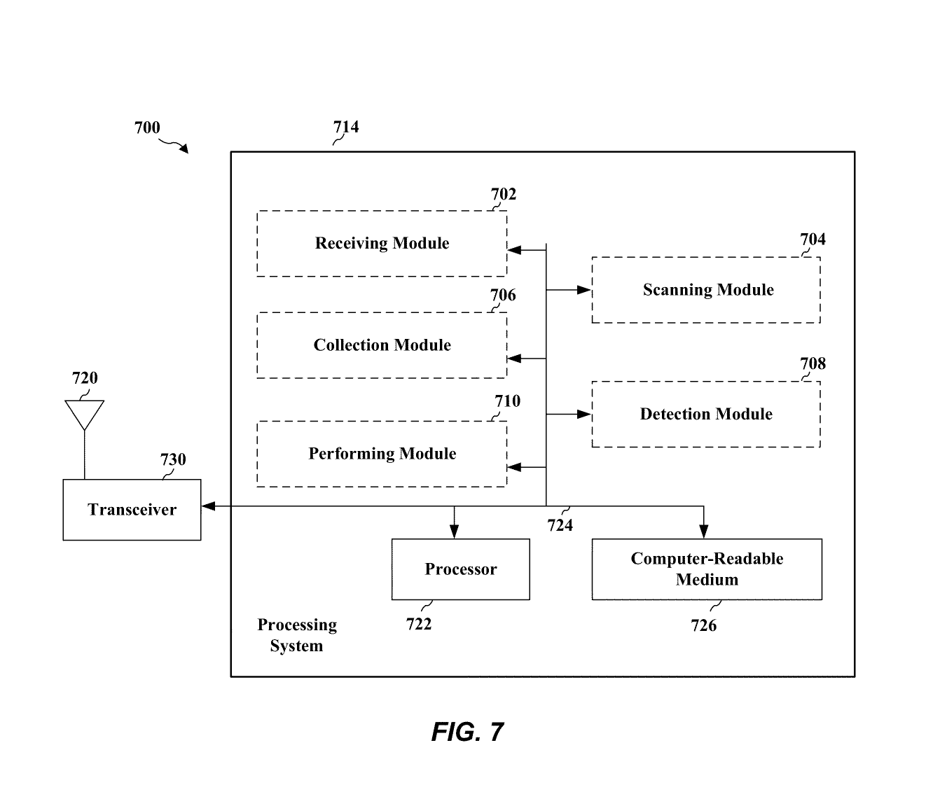

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, 706, 708, 710 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a receiving module 702 for receiving a redirection message. The processing system 714 includes a scanning module 704 for scanning frequencies of RATs. The processing system 714 includes a collection module 706 for collecting system information. The processing system 714 includes a detection module 708 for detecting cells. The processing system 714 includes a performing module 710 for performing call setup.

The modules may be software modules running in the processor 722, resident/stored in the computer readable medium 726, one or more hardware modules coupled to the processor 722, or some combination thereof. The processing system 714 may be a component of the UE 350 and may include the memory 392, and/or the controller/processor 390.

In one configuration, an apparatus such as a UE 350 is configured for wireless communication including means for receiving. In one aspect, the receiving means may be the antennas 352, the receiver 354, the channel processor 394, the receive frame processor 360, the receive processor 370, the controller/processor 390, the memory 392, call setup module 391, receiving module 702, and/or the processing system 714 configured to perform the receiving. The UE is also configured to include means for scanning. In one aspect, the scanning means may be the antennas 352, the receiver 354, the channel processor 394, the receive frame processor 360, the receive processor 370, the controller/processor 390, the memory 392, call setup module 391, scanning module 704 and/or the processing system 714 configured to perform the scanning. In one configuration, the means functions correspond to the aforementioned structures. In another aspect, the aforementioned means may be any module or any apparatus configured to perform the functions recited by the aforementioned means.

The UE is also configured to include means for collecting. In one aspect, the collecting means may be the antennas 352, the receiver 354, the channel processor 394, the receive frame processor 360, the receive processor 370, the controller/processor 390, the memory 392, call setup module 391, collection module 706 and/or the processing system 714 configured to perform the collecting. The UE is also configured to include means for detecting. In one aspect, the detecting means may be the antennas 352, the receiver 354, the channel processor 394, the receive frame processor 360, the receive processor 370, the controller/processor 390, the memory 392, call setup module 391, detection module 708 and/or the processing system 714 configured to perform the detecting. The UE is also configured to include means for performing. In one aspect, the performing means may be the antennas 352, the receiver 354, the channel processor 394, the receive frame processor 360, the receive processor 370, the transmitter 356, the transmit frame processor 382, the transmit processor 380, the controller/processor 390, the memory 392, call setup module 391, performing module 710 and/or the processing system 714 configured to perform the performing. In one configuration, the means functions correspond to the aforementioned structures. In another aspect, the aforementioned means may be any module or any apparatus configured to perform the functions recited by the aforementioned means.

Several aspects of a telecommunications system has been presented with reference to LTE, GSM and TD-SCDMA. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a redirection message from a first radio access technology (RAT) to move to a second RAT;
scanning frequencies of the second RAT indicated in the received redirection message from the first RAT but not detecting a cell;
scanning a third RAT;
collecting system information from a detected cell in the third RAT but not camping on the detected cell in the third RAT;
scanning frequencies of the second RAT indicated in the collected system information,
detecting a cell when scanning frequencies of the second RAT indicated in the collected system information; and
performing a call setup with the detected cell of the second RAT.

2. The method of claim 1, in which scanning frequencies of the second RAT indicated in the collected system information comprises scanning only frequencies of the second RAT that are different than the frequencies indicated in the received redirection message.

3. The method of claim 1, further comprising scanning frequencies of the second RAT based on neighbor frequencies indicated from collected system information from a second RAT cell not suitable for camping.

4. The method of claim 1, in which for a multi-subscriber identity module (SIM) device, a first SIM performs the call setup with a serving cell of the second RAT and skips scanning frequencies when a second SIM is camping on the serving cell of the second RAT.

5. The method of claim 1, further comprising:
comparing the cell detected during scanning, by a first SIM of a multi-subscriber identity module (SIM) device, with a serving cell of a second SIM; and
selecting a better cell for performing the call setup for the first SIM.

6. An apparatus for wireless communication, comprising:
means for receiving a redirection message from a first radio access technology (RAT) to move to a second RAT;
means for scanning frequencies of the second RAT indicated in the received redirection message from the first RAT but not detecting a cell;
means for scanning a third RAT;
means for collecting system information from a detected cell in the third RAT but not camping on the detected cell in the third RAT;
means for scanning frequencies of the second RAT indicated in the collected system information,
means for detecting a cell when scanning frequencies of the second RAT indicated in the collected system information; and
means for performing a call setup with the detected cell of the second RAT.

7. The apparatus of claim 6, in which the means for scanning frequencies of the second RAT indicated in the collected system information comprises means for scanning only frequencies of the second RAT that are different than the frequencies indicated in the received redirection message.

8. The apparatus of claim 6, further comprising means for scanning frequencies of the second RAT based on neighbor frequencies indicated from collected system information from a second RAT cell not suitable for camping.

9. The apparatus of claim 6, in which the apparatus is a multi-subscriber identity module (SIM) device, and in which a first SIM performs the call setup with a serving cell of the second RAT and skips scanning frequencies when a second SIM is camping on the serving cell of the second RAT.

10. The apparatus of claim 6, further comprising:
means for comparing the cell detected during scanning, by a first SIM of a multi-subscriber identity module (SIM) device, with a serving cell of a second SIM; and
means for selecting a better cell for performing the call setup for the first SIM.

11. A computer program product for wireless communication in a wireless network, comprising:
a non-transitory computer-readable medium having non-transitory program code recorded thereon, the program code comprising:
program code to receive a redirection message from a first radio access technology (RAT) to move to a second RAT;
program code to scan frequencies of the second RAT indicated in the received redirection message from the first RAT but to not detect a cell;
program code to scan a third RAT;
program code to collect system information from a detected cell in the third RAT but not camping on the detected cell in the third RAT;
program code to scan frequencies of the second RAT indicated in the collected system information,
program code to detect a cell when scanning frequencies of the second RAT indicated in the collected system information; and
program code to perform a call setup with the detected cell of the second RAT.

12. The computer program product of claim 11, in the program code to scan frequencies of the second RAT indicated in the collected system information is further configured to scan only frequencies of the second RAT that are different than the frequencies indicated in the received redirection message.

13. The computer program product of claim 11, further comprising program code to scan frequencies of the second RAT based on neighbor frequencies indicated from collected system information from a second RAT cell not suitable for camping.

14. The computer program product of claim 11, in which for a multi-subscriber identity module (SIM) device, a first SIM performs the call setup with a serving cell of the second RAT and skips scanning frequencies when a second SIM is camping on the serving cell of the second RAT.

15. The computer program product of claim 11, further comprising:
program code to compare the cell detected during scanning, by a first SIM of a multi-subscriber identity module (SIM) device, with a serving cell of a second SIM; and
program code to select a better cell for performing the call setup for the first SIM.

16. An apparatus for wireless communication, comprising:
a memory; and
at least one processor coupled to the memory, the at least one processor being configured:
to receive a redirection message from a first radio access technology (RAT) to move to a second RAT;
to scan frequencies of the second RAT indicated in the received redirection message from the first RAT but to not detect a cell;
to scan a third RAT;
to collect system information from a detected cell in the third RAT but not camping on the detected cell in the third RAT;
to scan frequencies of the second RAT indicated in the collected system information,
to detect a cell when scanning frequencies of the second RAT indicated in the collected system information; and
to perform a call setup with the detected cell of the second RAT.

17. The apparatus of claim 16, in which the at least one processor configured to scan frequencies of the second RAT indicated in the collected system information is further configured to scan only frequencies of the second RAT that are different than the frequencies indicated in the received redirection message.

18. The apparatus of claim 16, in which the at least one processor is further configured to scan frequencies of the second RAT based on neighbor frequencies indicated from collected system information from a second RAT cell not suitable for camping.

19. The apparatus of claim 16, in which for a multi-subscriber identity module (SIM) device, a first SIM performs the call setup with a serving cell of the second RAT and skips scanning frequencies when a second SIM is camping on the serving cell of the second RAT.

20. The apparatus of claim 16, in which the at least one processor is further configured:
to compare the cell detected during scanning, by a first SIM of a multi-subscriber identity module (SIM) device, with a serving cell of a second SIM; and
to select a better cell for performing the call setup for the first SIM.
